(19) United States
(12) Patent Application Publication
(10) Pub. No.: US 2017/0153624 A1
(43) Pub. Date: Jun. 1, 2017

(54) ASSEMBLY LINE EFFICIENCY SYSTEM

(71) Applicant: CHRISTOPHER STOTT CAMERON, WOOD RIVER, IL (US)

(72) Inventor: CHRISTOPHER STOTT CAMERON, WOOD RIVER, IL (US)

(21) Appl. No.: 14/954,086

(22) Filed: Nov. 30, 2015

(51) Int. Cl. G05B 19/4063

(52) U.S. Cl. CPC G05B 19/4063; G05B 2219/50185

(57) ABSTRACT

A system and method for determining and visually displaying efficiency rates for a production or assembly line has three main parts. A computer accepts predetermined data that sets a baseline rate and a target rate of production of units and data from a counter that counts the actual number of units being produced. The counter is most commonly an electric eye attached at a strategic point in the production or assembly line by a magnetic base. A three light visual display has Green, Yellow and Red lights to visually display whether the actual rate of production of units is above the target rate, below the target rate but above the baseline rate or below the baseline rate. The computer screen allows for data input (baseline and target rates, time period measured), worker breaks and product “Changeovers” and may also show graphics depicting the amount of time in which the production or assembly line is at or below the baseline and target rates or in between those rates.

### BACKGROUND OF THE INVENTION

This invention relates to the field of automated production and assembly lines. More particularly, a system of sensors, computational devices and displays is presented that enables a workman or Supervisor to monitor the rate of production and compare it to a normal or average rate of production.

Most modern factories are automated. With this automation, finished units may be produced at a much greater rate than non-automated assembly or production lines. Units produced per unit of time (usually per minute, per hour or per shift) translate into efficiency which translates into lowering the cost per unit. Obviously, a lower per unit cost increases the profit or lowers the cost of the unit, depending upon the desires of the manufacturing plant or demands of the marketplace.

The current system is designed to be used in production operations to track efficiency and to compare the actual production to baseline results. The system is applicable to manual, semi-automated and automated production lines. Calculations can be made by specially trained manufacturing efficiency experts or by the workmen, supervisors or management of the factory that determine an average rate of production, a below average rate of production or a highly efficient rate of production. Once this average rate is determined, a goal of efficiency can be determined that sets the number of units produced or processed per unit of time as average, below average of efficiently above average.

Monitoring the number of finished units produced has been well known and used throughout the manufacturing art for many years. The use of electronic eyes to count the number of finished units has been routinely employed. The electric eyes are placed at strategic places in the assembly or production line. Electric eyes usually count the units by sending a signal when there is a space between parts or rows of finished units. Mere counting of parts on an assembly or production line is not new. However, the instant invention provides a new and useful improvement to the simple counting process by coupling the counting of parts with the rate of production and also providing a visual instantaneous signal to the individual workman and supervisor that monitors and signals the efficiency of the line. It is a major object of this invention to provide a system for monitoring and visually signaling the efficiency of a production or assembly line.

Several prior inventions have been made public or been granted a United States patent that help to improve the efficiency of the production or assembly line. For example, the 2002 patent issued to Yoshiyuki (U.S. Pat. No. 6,345,208) discloses a method and apparatus for production management. Yoshiyuki has a computer that shows the number of parts corresponding to a number of products and is coupled to a parts supplying section which supplies parts to fulfill the production line desired quota. The method described in this production management system supplies parts efficiently to an assembly line that ultimately produces finished units. While this patent counts parts and makes the line more efficient thereby, it does not solve the problem of monitoring assembly or production lines with visual signals to a worker or supervisor. It is an object of this invention to provide a system of production that creates a visual signal to a worker or supervisor that the rate of units being produced at a given point in the system is efficient, average or below average.

Another patent of interest was issued to Sun in 2015 for a production scheduling management system. Sun (U.S. Pat. No. 9,141,581) provides a system for scheduling production events for a number of production resources used to manage one or more products relative to time intervals. Sun is useful for its intended purpose but does not allow for the monitoring of individual points along the assembly line for efficiency with respect to an above or below average output. The Sun patent and method claim, however, does not make any comparison to efficiency over time as it relates to adjusting the rate of production on an assembly. It is another object of this invention to provide a monitor and visual display of production at any given place in an assembly or production line with respect to above, average or below units produced per time span.

A final patent application of interest is the 2012 application of Saito (US 2012/0078404 A1) for a consumption rate calculator for controlling consumption of energy per unit of production. Saito has that includes “an operation information outputter” that has a means to acquire time-series data for a physical quantity produced and a production-quantity calculator that calculates a production quantity of products and compares it to the power consumption of the production. Saito compares product to energy consumption and allows the supervisor of management to monitor the rate of energy. Although Saito does compare production units to energy consumed, it has no visual read out or warning such that a workman or supervisor can adjust the rate of production as does the present invention. It is a still further object of this invention to provide a system of production management that compares rate of production over time and that provides an instantaneous visual display of the efficiency of an assembly or production line.

Other and further objects of this invention will become obvious upon reading the below described Specification.

### BRIEF DESCRIPTION OF THE INVENTION

An efficiency monitoring system has three main sections. A first section monitors the number of units being produced at a specified or desired place in an assembly or production line. This unit production counter is typically an electric eye counter. A second programmable computer section receives the input data from the counter and translates the unit production information into a unit per time output. A third section displays the unit per time data such that the individual workman on the line and his supervisor can have instantaneous access to the data. The display is a graphic visual display on a screen and a three light visual display that has a “Green” light (above average and efficient), “Yellow” light (above average but not yet efficient), and a “Red” light (at or below a minimum unit per time production. The efficiency of the production or assembly line can be constantly and instantaneously monitored such that the workman or supervisor can adjust the efficiency of the line accordingly.

### BRIEF DESCRIPTION OF THE DRAWINGS

FIG. 1 is a perspective view of the computer module and display.

FIG. 2 is a perspective view of the visual light stand, part of the display element of the system.

FIG. 3 is a view of the electric eye counting element of the system, showing especially the magnetic base and flexible stem for the electric eye.

FIG. 4 is a view of the center part of the control module visual screen display.

FIG. 4A is a view of the control module visual screen display with the keypad activated.

FIG. 5 is a view of the control module visual screen “Graphics” display showing the bar graphs available to the individual workman or supervisor.

### DETAILED DESCRIPTION OF THE INVENTION

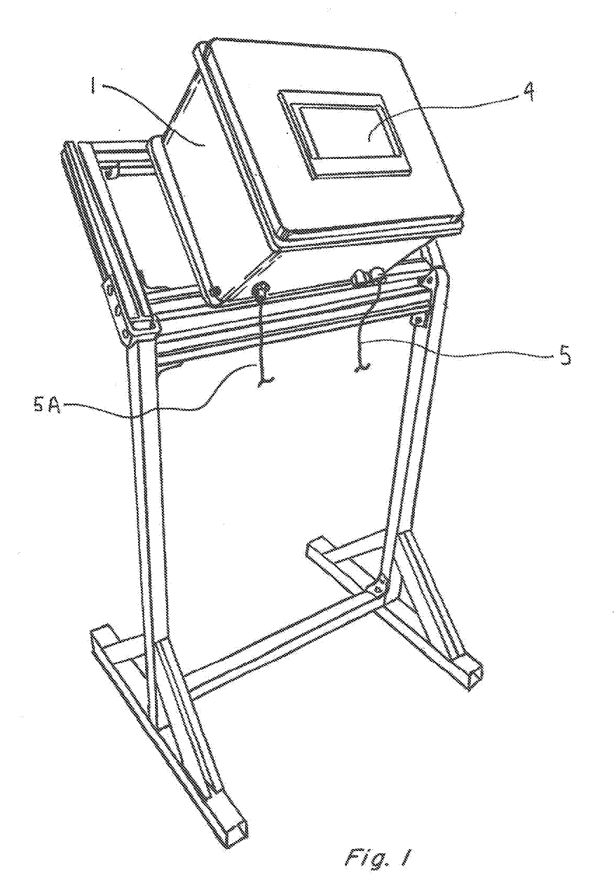

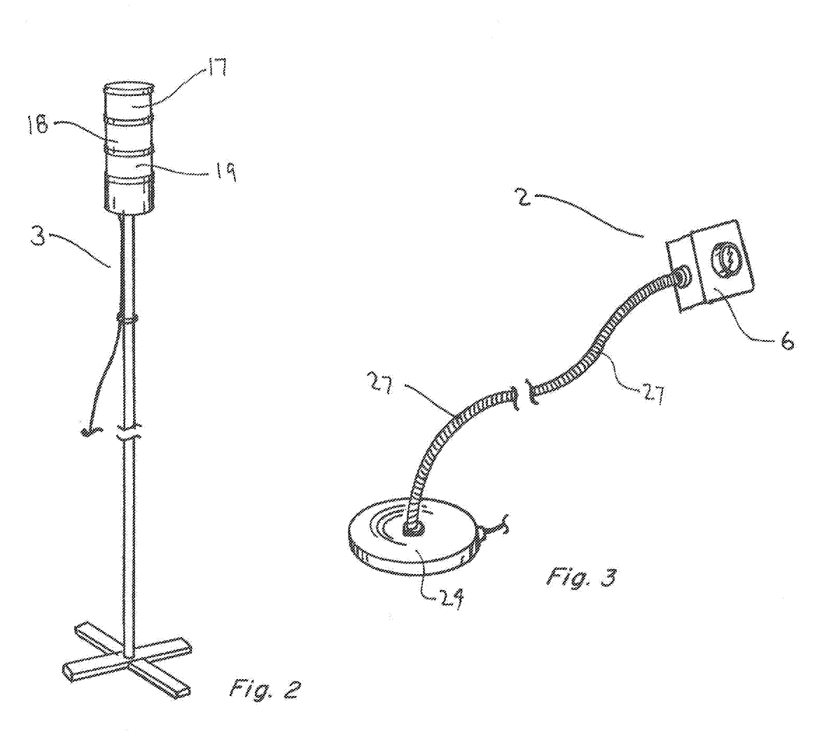

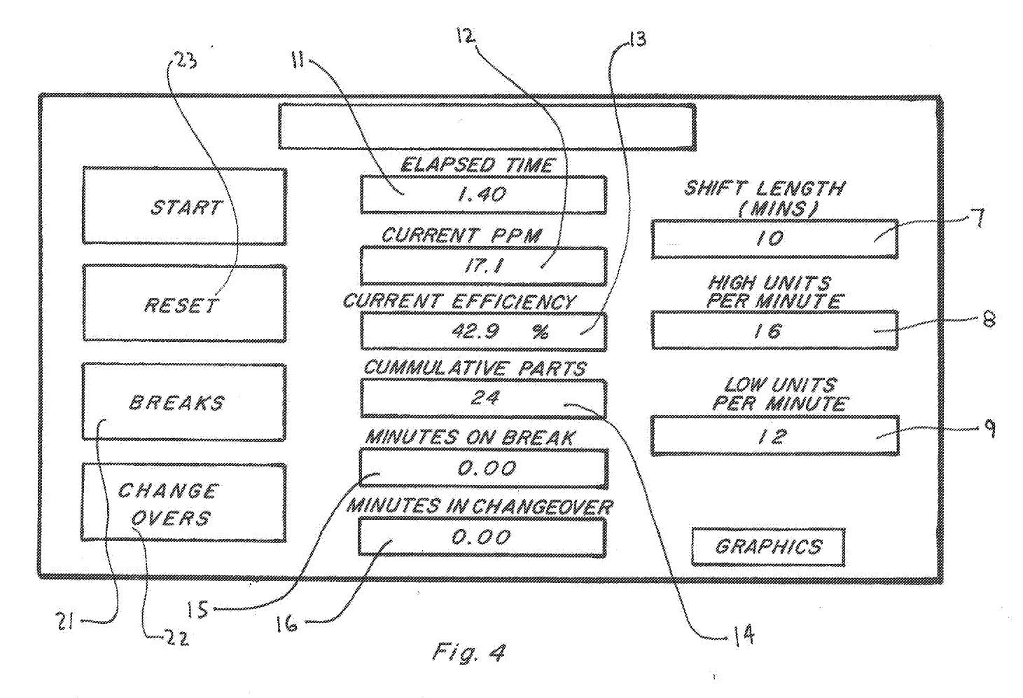

The assembly line efficiency system has three main parts. A control module 1 (FIG. 1) collects data from a counter 2 (FIG. 3) and translates it into efficiency information. The information is displayed visually on the computer output screen display and is transmitted to an upright visual light bar 3 (FIG. 2). The information enables a Supervisor or workman to monitor the assembly line efficiency at various spots on the assembly line and to control the output of the line in the most efficient manner.

The control module 1 has two main electronic parts, a visual screen display 4 and a PLC computer unit located inside the control module. The inner computer has a timer. The voltage converter converts standard 120 volts to 24 volts to supply the PLC. The PLC computer receives input from an electric eye 6 counter or other counting device and translates the data received into selected outputs. The electric eye 6 is electrically connected to the control module 1 by a cord 5 or by other means

The electric eye records the number of units actually produced. The data comprises the number of units produced and is electrically transmitted to the computer. The computer calculates the number of units produced per time period and compares it to a baseline rate and a target rate of production. The baseline units produced rate and the target number of units produced rate are determined and calculated by a supervisor or efficiency expert prior to the use of the system and are inputted into the computer.

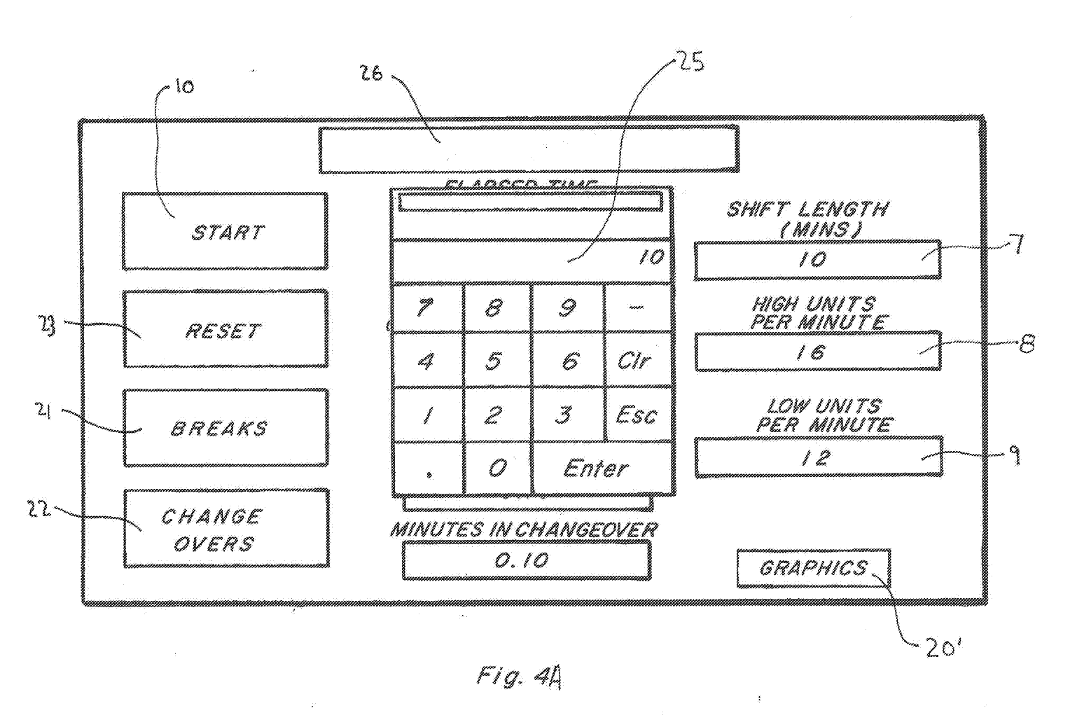

As shown on FIGS. 1 and 4, the control module has a main visual screen display 4 located on the face of the box. The display has several input parameter buttons located on the right side of the display. As shown on FIG. 3, a “SHIFT LENGTH” button 7 sets the length of the shift or segment of a shift that needs to be monitored, for example 480 minutes for an average shift. (FIG. 4 shows a shift length as 10 minutes for an example. The shift length may be set manually by engaging the keypad 25 as best shown in FIG. 4A.) A space for labelling the unit 26 is also provided. The SHIFT LENGTH button 7 may be set at any desired length in minutes, as, for example 10 minutes as shown, to monitor the efficiency of the point in the assembly line for that period of time.

A “HIGH” button 8 allows the Supervisor or Technician to input a target number of parts per time units (in the case shown, minutes) equal to a high efficiency use of the assembly line. This “HIGH” input would be determined by the Plant manager, Supervisor or Efficiency Technician. The “High” number would vary according to the individual goals and specific requirements of the assembly line being monitored.

A “LOW” button 9 would set the minimum number of units for the assembly that is an acceptable minimum production.

The visual screen display, shown best in FIG. 4, shows the rate of production of units as compared to the baseline rate and the target rate and visually displays whether or not the actual production rate is below, at or above the baseline and target rates over the ELAPSED TIME period. For example, as shown on FIG. 4, 24 CUMULATIVE PARTS over 1.4 minutes of ELAPSED TIME equals 17.1 PPM over 1.4 minutes. 17.1 PPM is 142.9 percent CURRENT EFFICIENCY for the 1.4 minutes with a LOW baseline of 12 parts per minute.

The control module 1 is electrically connected to a counter 2 and to an upright visual light bar 3. The counter 2, best shown on FIG. 3, is usually an electric eye 6 located on the assembly line in a manner that allows the electric eye to count parts produced. The electric eye 6 usually counts parts by determining the spaces between parts and sending an electric signal to the PLC.

Once the efficiency parameters High 8 and Low 9 and monitoring time (Shift Length) 7 have been set and inputted into the control module 1, and the electric eye 2 has been set up, the control module may be started by pushing the “Start” button 10. Once the control unit is started, a read-out of parts per minute may be instantaneously calculated. The control module calculates the parts per time unit (minutes) produced and compares it to the Low number and the High number previously set in 15 second segments. The CURRENT PPM is an instantaneous calculation and tells the Supervisor how the line is performing at the precise moment in time.

The visual screen display 4 displays elapsed time 11, current parts per minute 12, current efficiency 13, cumulative parts 14, minutes on Break 15 and minutes in changeover 16, as best shown on FIG. 4. For FIG. 4, the numbers shown are read-outs from the counter 6 over an example 1.4 minutes of ELAPSED TIME.

Actual performance data is visible not only on the control module visual screen display 4 but also on an upright light bar 3 electrically connected to said control module 1 by cord 5A. The upright light bar 3 has three intuitive light sections. The three intuitive lights inform the production team how they are performing on a continuing basis. Only one section is lighted at a time. If the parts per minute is equal to or greater than the High number of parts per minute the top section of the light bar is lighted showing a green light 17. If the parts per minutes is less than High but greater than Low, a middle yellow light 18 is lighted. If the parts per minute is less than the Low number, a lower third red light 19 is lighted. Only one intuitive light 17, 18 or 19 is lighted at a time. The three light display is easily interpreted by anyone in the line of sight of the display, whether workman, supervisor or management. The lights function based on elapsed time.

The three light system indicates that the work team is performing at or below the previously established baseline (Red); above the baseline but not at the targeted goal (Yellow); or at or above the targeted efficient goal (Green).

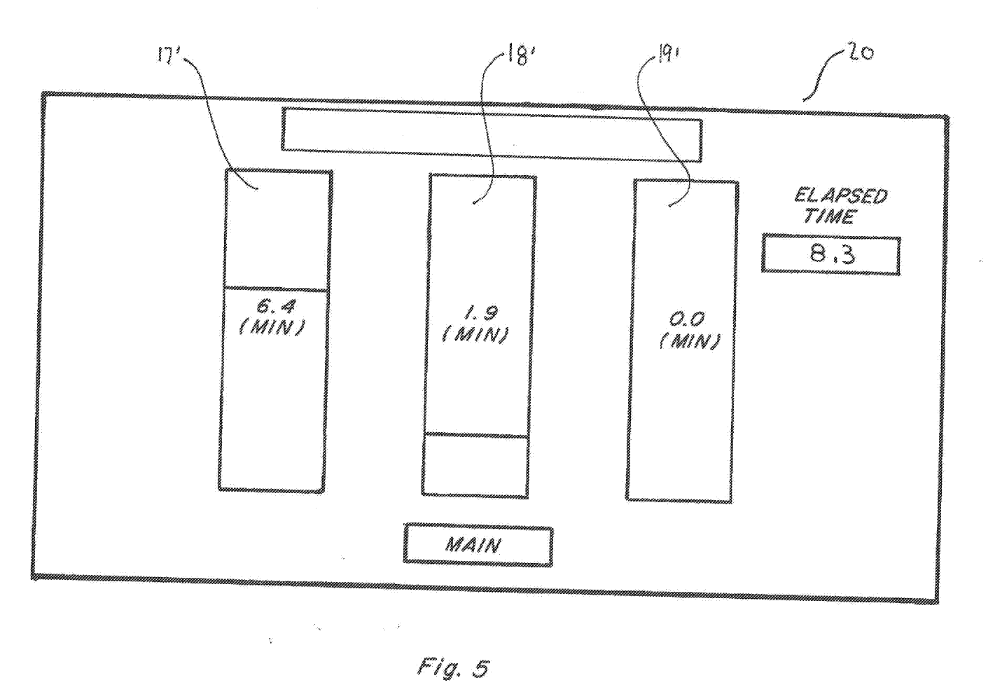

Another feature of the visual screen display is the visual screen graphics display 20 shown in FIG. 5. When the Graphics button 20′ on the display is actuated, the bar graphics display 20 is generated, as shown. The bar graph shows the amount of time the production line has produced the targeted goal of units per minute at or above the target (Green time) 17′, between the target goal and the baseline (Yellow time) 18′ and at or below the baseline (Red time) 19′ over the ELAPSED TIME for the SHIFT. The SHIFT input only effects the bar graphs.

Since typical assembly lines allow for breaks for workers and product changeovers, settings for interruptions for breaks 21 and for product changeovers 22 are also provided. The “BREAK” calculation keeps track of the duration of worker breaks. The “CHANGEOVER” button allows for changes in the line to a different product and the duration is likewise measured. Shift changes are a source of lost time. If the line stops at such a time it will adversely affect efficiency.

Once the optimum calculations have been set in the computer, the system becomes operational by pressing the “START” button 10. The system may be reprogrammed (as to optimal High and Low and reset as to time) by pressing the RESET button 23.

As best shown in FIG. 3, the electric eye counting unit 2 has three main components. The counting unit has a heavy, magnetic base for attaching the counting unit in an appropriate place to the assembly line. The electric eye 6 is attached to the base 24 by a flexible stem 27. The flexible stem allows for the technician installing the counting unit to place the eye in a position that allows efficient counting of parts produced.

In actual operation, for example, current inefficient output would be a preset number. Operations producing at or below that number of units would produce a Red light. When a supervisor sees a Red light, he can go to that work station and attempt to improve production efficiency at that point in the line. Typically, only one system is used per line. The supervisor may easily identify the problem by observing the bottleneck and talking with the line leadership or work team.

The three light display may also be flash at a point where either the Green, Yellow or Red parameters are approaching a changeover in the efficiency rating. This occurs when the production rate is so slow that the PLC calculates at a rate greater than the production rate.

The PLC can be programmed with many varying parameters to adapt to various production lines. For example, current efficiency can be outputted in 30 second or two minute intervals, or 2 parts per minute or one part per two minutes or any other unit per time ratio desired. However, the standard and preferred method is parts per minute calculated every 15 seconds.

1. A system for measuring the efficiency of producing manufacturing units for an assembly or production line, comprising:
(1) a computer control module having a timer that accepts input data from a counter, wherein said data comprises the number of units produced, wherein said computer calculates the number of units produced per time period and compares said rate to a baseline rate and a target rate of production;
(2) a counter, electrically connected to said computer, wherein said counter records the number of units produced and transmits said data to said computer;
(3) at least one visual display electrically connected to said control module, wherein said at least one visual display shows the rate of production of units as compared to said baseline rate and said target rate and visually displays whether or not the production rate is below, at or above said baseline rate or target rate.

2. A system for measuring the efficiency of producing manufacturing units for an assembly or production line, as in claim 1, wherein said counter comprises an electric eye counting mechanism for counting actual units of production.

3. A system for measuring the efficiency of producing manufacturing units for an assembly or production line as in claim 1, wherein said counter comprises an electric eye connected to a magnetic base by a flexible stem.

4. A system for measuring the efficiency of producing manufacturing units for an assembly or production line, as in claim 1, wherein said visual upright display comprises two or more intuitive lights to visually display whether or not the production line is producing units below, at or above a baseline rate and a target rate.

5. A system for measuring the efficiency of producing manufacturing units for an assembly or production line, as in claim 1, comprising a first visual screen display that shows the baseline and target rates of production units and a second visual screen display bar graph that shows the amount of time in which the production line has produced units below the baseline rate, above the baseline rate but below the target rate and above the target rate of production units.

6. A system for measuring the efficiency of producing manufacturing units for an assembly or production line, as in claim 1, comprising a lighted visual upright display comprising two or more intuitive lights to visually display whether or not the production line is producing units at, below or above a baseline rate and a target rate and a visual screen display that shows the baseline and target rates of production units and a bar graph that shows the amount of time in which the production line has produced units below the baseline rate, above the baseline rate but below the target rate and above the target rate of production units.

7. A method for monitoring the efficiency of a production or assembly line, comprising the steps of:
(1) determining the number of baseline units produced rate and a target number of units produced rate and inputting these rates into a computer;
(2) counting the actual number of units produced per time period on an assembly or production line;
(3) comparing the actual number of units produced per time to the baseline and target rates;
(4) visually displaying intuitive colored lights to show whether or not the production or assembly line is producing units at or below said baseline rate, above said baseline rate but below said target rate or at or above said baseline rate.
